(19) United States
(12) Patent Application Publication
(10) Pub. No.: US 2006/0257155 A1
(43) Pub. Date: Nov. 16, 2006

(54) Fuser roll using radio frequency identification

(75) Inventors: Kenneth Schlafer, Fairport, NY (US); Ewart LeBlanc, Fairport, NY (US); Richard LaBombard, Williamson, NY (US)

Correspondence Address: PEPPER HAMILTON LLP, ONE MELLON CENTER, 50TH FLOOR, 500 GRANT STREET, PITTSBURGH, PA, 15219, US

(73) Assignee: Xerox Corporation

(21) Appl. No.: 11/127,416

(22) Filed: May 12, 2005

(51) Int. Cl. G03G 15/00

(52) U.S. Cl. 399/12; 399/24

(57) ABSTRACT

A fuser member using an RFID tag and a method for evaluating the performance of a fuser member using a RFID tag are disclosed. An RFID tag may be attached to a fuser member during a manufacturing process. Production data pertaining to the fuser member may be stored on the RFID tag during the manufacturing process as well. Once manufactured, the fuser member may be used in a xerographic apparatus. Run-time data may be stored in the RFID tag during operating of the xerographic apparatus. After the fuser member is removed from the xerographic apparatus, the performance of the fuser member may be evaluated by examining the run-time data. The fuser member may include a core, optionally made of metal, an insulating layer, and an RFID tag.

### TECHNICAL FIELD

The disclosed embodiments generally relate to methods and systems for using fuser member technology in an electrographic and/or xerographic apparatus. More particularly, the disclosed embodiments relate to a fuser member incorporating a Radio Frequency Identification (RFID) tag used to provide feedback data and/or metrics regarding operation of the fuser member.

### BACKGROUND

In a typical electrographic or xerographic copying or printing process, a charge retentive surface such as a photoconductive member is charged to a substantially uniform potential so as to sensitize the surface thereof. The charged portion of the photoconductive member is selectively exposed to light to dissipate the charges thereon in areas subjected to the light. This records an electrostatic latent image on the photoconductive member. After the electrostatic latent image is recorded on the photoconductive member, the electrostatic latent image is rendered visible by bringing one or more developer materials into contact therewith. Generally, the developer material comprises toner particles adhering triboelectrically to carrier granules. The toner particles are attracted from the carrier granules either to a donor member or to a latent electrostatic image on the photoconductive member. When attracted to a donor member, the toner particles are subsequently deposited on the latent electrostatic images. The toner powder image is then transferred from the photoconductive member to a final substrate or imaging media. The toner particles forming the toner powder images are then subjected to a combination of heat and/or pressure to permanently affix the powder images to the substrate.

In order to permanently fix or fuse the toner material onto a substrate or support member, such as plain paper, by heat, it is necessary to elevate the temperature of the toner material to a point at which constituents of the toner material coalesce and become tacky. This action causes the toner to flow to some extent onto the fibers and/or into the pores of the support member or otherwise upon the surface thereof. Thereafter, as the toner material cools, solidification of the toner material occurs causing the toner material to be bonded firmly to the support member.

Fuser rolls are one type of fuser asseembly commonly used to heat the toner material and cause it to fuse to the substrate. Fuser rolls typically operate at temperatures up to approximately 200° C. A fuser roll rotates around an axis as the substrate is drawn between it and a pressure roll. Heat is applied to the toner material via the fuser roll during this drawing process.

The performance of a nip-forming fuser member in an electrographic or xerographic apparatus is dependent upon its operating conditions. For example, the percent extractables in the overcoat layer of the fuser member and the hardness of the silicone rubber of the fuser member are of particular importance. The percent extractables has a significant effect on release. The hardness of the fuser member has a significant effect on setting the nip-width for the fuser member. Even though such data is being measured for fuser members, the electrographic or xerographic apparatus cannot make adjustments to its fuser module based on the processing conditions of the fuser member because the measurement data is not collocated with the fuser member.

What is needed is a fuser member that includes updatable storage locations for storing data pertaining to the properties and/or operation of the fuser member.

A need exists for a fuser member that can transmit data from and/or receive data at such storage locations from a location remote from the fuser member.

A need exists for a fuser member that can transmit and receive data without a physical connection because the rotation of the fuser member during normal operation inhibits a continuous physical connection between circuitry placed on the fuser member and the remainder of the fuser module.

A need exists for a transmission and reception system within a fuser member that is temperature resistant at least under normal manufacturing conditions and normal operating temperatures for the fuser member.

A need exists for a low-cost data transmission and reception system within a fuser member.

A further need exists for a data transmission and reception system that is sized to be placed on a fuser member.

The present invention is directed to solving one or more of the above-listed problems.

### SUMMARY

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope.

It must also be noted that as used herein and in the appended claims, the singular forms “a,” “an,” and “the” include plural references unless the context clearly dictates otherwise. Thus, for example, reference to an “RFID tag” is a reference to one or more RFID tags and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the invention, the preferred methods, materials, and devices are now described. All publications mentioned herein are incorporated by reference. Nothing herein is to be construed as an admission that the invention is not entitled to antedate such disclosure by virtue of prior invention.

In an embodiment, a fuser assembly may include a roll pair maintained in pressure contact, a belt member in pressure contact with a roll, a belt member in pressure contact with a heater, a plate member in pressure contact with a roll, a plate member in pressure contact with a heater, or the like. Heat may be applied by heating one or both of the rolls, plate members, or belt members. At least one of these members may have a thermally conductive layer covering at least a portion of a core, and an RFID tag attached to it.

In an embodiment, a method for evaluating performance of a fuser member may include manufacturing a fuser member, attaching an RFID tag to the fuser member, storing production data pertaining to the fuser member in the RFID tag, using the fuser member in a xerographic apparatus, storing run-time data in the RFID tag during operation of the xerographic apparatus, and evaluating performance of the fuser member based on the run-time data.

### BRIEF DESCRIPTION OF THE DRAWINGS

Aspects, features, benefits and advantages of the embodiments of the present invention will be apparent with regard to the following description, appended claims and accompanying drawings where:

FIG. 1 depicts a life cycle diagram for an exemplary fuser member designed according to an embodiment.

FIG. 2 depicts an RFID tag as positioned on an exemplary fuser member according to an embodiment.

### DETAILED DESCRIPTION

A fuser member may include a material that exhibits insulating properties and is thus capable of retaining an electric charge applied to its surface. The fuser member may be formulated entirely of the insulating material, or it may include a core of a material such as copper, aluminum, steel, other metal or other suitable materials coated with the insulating material. In addition, a fuser member may be employed as the core and an insulating charged material may be coated on its surface, thereby maintaining any desirable mechanical and thermal properties of the fuser member and also reducing or eliminating offset.

When the surface of the fuser member is charged, the insulating material need not possess perfect insulating characteristics; it may be sufficient for the material to retain the applied charge until recharging can occur. Suitable insulating materials for the fuser member may include tetrafluoroethylene, HTV (high temperature vulcanization-type) silicone rubber, RTV (room temperature vulcanization-type) silicone rubber, fluorinated polymers such as polytetrafluoroethylene, including Teflon®, available from E. I. duPont de Nemours and Co., Wilmington, Del., fluorocarbon elastomers, including the vinylidene fluoride-based fluoroelastomers which contain hexafluoropropylene as a comonomer, available as Viton® from E. I. DuPont de Nemours and Co., and other insulating polymers such as a saturated hydrocarbon, including poly(isobutylene), poly(ethylene) and poly(propylene), polystyrene, polybutadiene, polynorbomadiene, a poly(arylene), such as poly(p-xylylene), a poly(ethylene terphthalate), a poly(ether ether ketone), a poly(carbonate), a poly(carbonate-co-ester), a poly(sulfone), a poly(arylate), a poly(etherimide), a poly(arylsulfone), a poly(ethersulfone), and a poly(amide-imide). Fuser members suitable for the process of the present invention are described in several publications, such as U.S. Pat. Nos. 3,256,002; 3,268,351; 3,841,827; 3,912,901; 4,078,286; 4,149,797; 4,196,256; 4,372,246; 4,935,785; 5,298,957; and 5,848,331, each of which is incorporated herein by reference in its entirety.

A fuser member may include a radio frequency identification (“RFID”) transponder circuit, also known as a RFID tag, which may allow an electrographic or xerographic apparatus' fuser module to sense coded processing information. Data, such as a batch number, a serial number, a production date, a percent extractables, a durometer measure, a hardness measure for the insulating material, a fault code, a yield rate, a page count, an operating temperature and/or other process information, may be stored within the transponder circuit on the fuser member. The hardness measure for the insulating material may indicate the softness and/or deflection of the insulating material on the fuser member. The hardness measure for the insulating material may be used to determine a nip width setting (i.e., the length of the contact arc between the fuser member and a pressure member). The percent extractables may indicate surface properties of a fuser member and pertain to the amount of curative that has not been removed from the fuser member. The data may enable fuser module adjustments to be made in an electrographic or xerographic apparatus based on the specific process conditions for a particular fuser member or a lot of fuser members. The RFID transponder may also be used to collect machine performance data and/or metrics, such as yield, fault codes, etc. This information may be collected when the fuser member is located in the electrographic or xerographic apparatus and may be analyzed when the fuser member is remanufactured. The data may further be analyzed when the fuser member is located in the electrographic or xerographic apparatus to enable adjustments to the operating conditions of the fuser member. Statistical data may be used to improve the design of future and current products.

A basic RFID system may include an RFID tag and an RFID reader. The RFID reader may include an antenna and a transceiver. The antenna may emit radio signals to activate the RFID tag and read and write data to it. The antenna may be the conduit between the RFID tag and the transceiver, which controls a system's data acquisition and communication. The electromagnetic field produced by an antenna may be constantly enabled when tags are expected continually. If constant interrogation is not required, a sensor device may be used to activate an electromagnetic field. The transceiver may include a decoder.

An RFID reader may emit radio waves that are perceptible at distances from about one inch to about 100 feet or more, depending upon the power output of the reader's antenna and the radio frequency used. When an RFID tag passes through the electromagnetic zone, the tag may detect the reader's activation signal. The reader may receive and decode data encoded in the tag's storage medium. The reader may then pass data on to, for example, a processor for processing.

RFID tags may be categorized as either active or passive. Active RFID tags may be powered by an internal battery and are typically read/write. In other words, tag data can be rewritten and/or modified. An active tag's memory size may vary to match application requirements. Some tags may include about 1 MB of memory or more. In a typical read/write RFID work-in-process system, a tag may transmit a set of instructions to a machine. The machine may, in turn, report its performance to the tag. This encoded data may become part of the tagged part's history. In general, an active tag may have a greater read range because its antenna is powered by a battery. However, active tags may tend to be larger, cost more and have a shorter operational life than passive tags.

Passive RFID tags operate without a separate external power source and may obtain operating power generated from the reader. Passive tags may consequently be much lighter than active tags, less expensive, and may offer a virtually unlimited operational lifetime. However, passive RFID tags may have shorter read ranges than active tags and may require a higher-powered reader. Read-only tags may typically be passive. Read-only tags may operate as a license plate into a database similar to the way that linear barcodes reference a database containing modifiable product-specific information.

RFID systems may also be distinguished by their frequency ranges. Low-frequency (about 30 KHz to about 500 KHz) systems may have short reading ranges and lower system costs. Such system most commonly may be used in security access, asset tracking, and animal identification applications. Ultra high-frequency and microwave systems (about 850 MHz to about 950 MHz, and about 2.4 GHz to about 2.5 GHz), offering long read ranges (greater than about 90 feet) and high reading speeds, may be used for such applications as railroad car tracking and automated toll collection. However, the higher performance of such RFID systems may incur higher system costs.

Radio waves may be used to transmit information between the tag and a reader. The maximum allowable distance between the RFID tag and a reader during a read/write operation may depend on factors such as the frequency of operation, the power of the reader, and interference from other RF devices or metal objects. In an embodiment, low frequency RFID tags may be used where the RFID tag is placed on a fuser member, and the reader is mounted inside the electrographic or xerographic apparatus or within remanufacturing equipment.

One significant advantage of RFID systems may be the non-contact, non-line-of-sight nature of the technology. Tags may be read through a variety of substances and other visually and environmentally challenging conditions. In contrast, other technologies, such as barcodes or other optically read technologies or other electrical technologies, may be unusable. RFID tags may be read in challenging circumstances at remarkable speeds, in some cases responding in less than about 100 milliseconds.

In an embodiment, an RFID tag may be designed to withstand the high temperatures present in the demanding manufacturing environment and normal operating temperature range of a fuser member. Accordingly, an RFID tag that survives operating temperatures and/or process temperatures of approximately 380° F. for extended periods of time may be desirable. An operating temperature may be the temperature at which the fuser member operates when placed in, for example, an electrographic or xerographic apparatus. The process temperature may be the temperature to which the fuser member is heated when fabricating or remanufacturing the fuser member. Such temperature resistant RFID tags may have, for example, a four-foot read range and a six-foot write range. The RFID tag may be factory or field programmed and may be updated an unlimited number of times. An integrated solution may be used to assemble the tag into the fuser member design and to assist with the set up of a system to collect the processing information for the fuser member. In an embodiment, real time data may be transmitted to a system based on a high frequency radio signal.

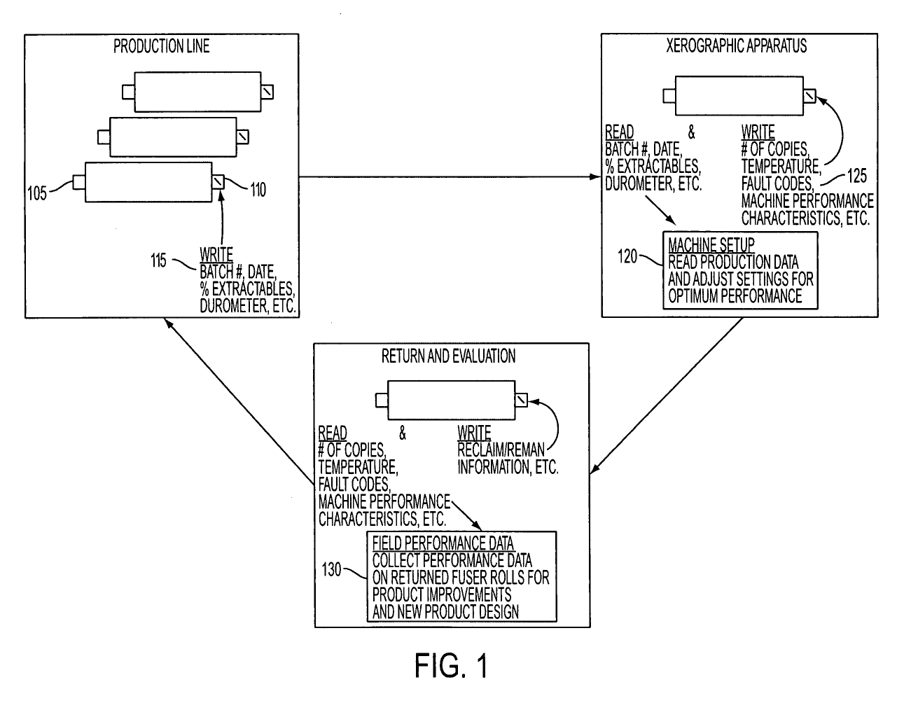

FIG. 1 depicts a life cycle diagram for an exemplary fuser member designed according to an embodiment. As shown in FIG. 1, a plurality of fuser members, such as 105, may be produced on, for example, a production line or remanufactured on, for example, a remanufacturing line. At the time of production, a RFID tag, such as 110, may be placed on the fuser member 105 and attached to the fuser member using, for example, an adhesive. In an embodiment, an adhesive may have one or more of a high bond strength, a high temperature stability, thermal shock resistance, chemical resistance, and/or low shrinkage. In an alternate embodiment, the RFID tag 110 may be attached to the fuser member 105 using a band (not shown). The band may affix the RFID tag 110 in place against the fuser member 105 by, for example, using constrictive force. As a result, the band may substantially prevent the RFID tag 110 from moving in relation to the fuser member 105. In an embodiment, the band may include a high performance, heat shrinkable fluoropolymer film. The RFID tag 110 may be programmed with information pertaining to characteristics of the fuser member 105. For example, the RFID tag 110 may be programmed with a batch number designating the batch of fuser members in which fuser member 105 was produced, a date of production, a percent extractables, a durometer measure, and/or other characteristics describing the composition and/or construction of the fuser member (generally, the production data 115). The percent extractables may be an indicator of the expected lifetime of the fuser member 105 based on the cure of the fuser member. The RFID tag 110 may be passive or active depending upon the requirements of the particular system for which the fuser member 105 is designed.

After the fuser member 105 is produced, it may be shipped to a customer site that includes an electrographic or xerographic apparatus (not shown) in which the fuser member 105 may be inserted. When the fuser member 105 is inserted and the apparatus is initialized, the apparatus may perform a machine setup function 120 during which the apparatus may read the fuser member's production data 115. The apparatus may then adjust one or more settings designed to optimize performance based on the production data 115.

During operation of the apparatus, run-time information 125 may be written to the RFID tag 110 on the fuser member 105. The run-time information 125 may include, without limitation, the number of copies and/or printed pages that the apparatus has produced, the temperature at which the fuser member 105 is operated, one or more fault codes depicting error or warning conditions within the apparatus, and/or one or more machine performance characteristics. The run-time information 125 may be updated over time by transmitting the information from the apparatus to the fuser member 105 using, for example, radio waves. Particularly, the apparatus may include an RFID transponder (not shown) that transmits the information to the RFID tag 110 on the fuser member 105 via an RF signal.

After a number of copies and/or printed pages are produced by the apparatus using the fuser member 105 and/or after a designated period of time from the time of installation of the fuser member in the apparatus, the fuser member may be replaced with a new fuser member in the apparatus. Upon removal from the apparatus, the fuser member 105 may be sent to a return and remanufacturing facility. During a remanufacturing process, the RFID tag 110 may be read using a second RF transponder (not shown) to retrieve the run-time information 125 from the fuser member 105. A field performance data process 130 may examine the run-time information 125 to determine if product improvements, such as product design improvements, may be made. After examining the run-time information 125, reclaiming information, remanufacturing information and/or other information may be written to the RFID tag 110. In an embodiment, the run-time information 125 stored on the RFID tag 110 may be overwritten. The re-initialized fuser member 105 may then be sent to the production line for remanufacture.

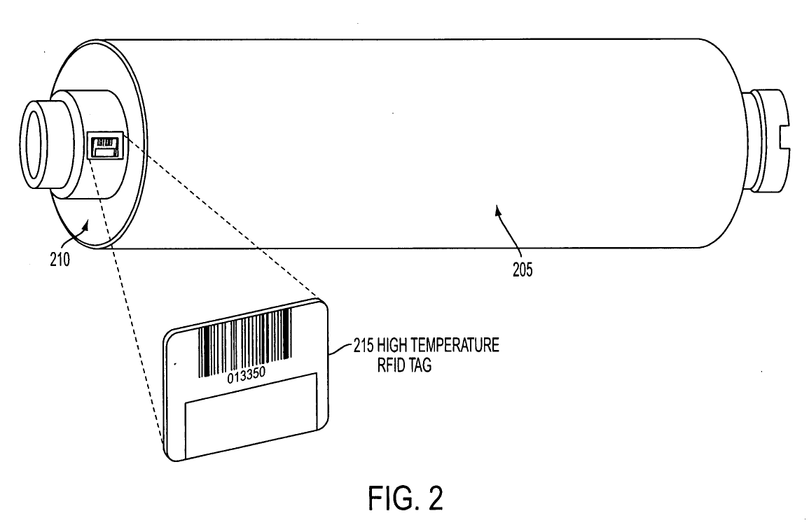

FIG. 2 depicts an exemplary fuser member according to an embodiment. As shown in FIG. 2, a fuser member 200 may include an insulating material 205, a core 210 and an RFID tag 215.

The insulating material 205 may contact the substrate onto which the toner particles are placed. The insulating material 205 may be heated to provide both heat and pressure to the substrate to affix the toner particles to the substrate.

The core 210 may be used to support the insulating material 205. The core 210 may further be the connection point between the fuser member 200 and the electrographic or xerographic apparatus into which the fuser member is placed.

In an embodiment, the RFID tag 215 may be placed on a portion of the core 210 that is not directly under the insulating material 205. This may enable the RFID tag 215 to communicate more freely with the transponder in the electrographic or xerographic apparatus. Moreover, placing the RFID tag 215 on the portion of the core 210 not directly under the insulating material 205 may protect the RFID tag during the remanufacturing process. Accordingly, the life of the RFID tag 215 may be extended.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A fuser member, comprising:
a core;
an insulating layer, wherein the insulating layer covers at least a portion of the core; and
an RFID tag, wherein the RFID tag is attached to or placed on the core.

2. The fuser member of claim 1 wherein the RFID tag comprises a storage medium containing data.

3. The fuser member of claim. 2 wherein the data includes one or more of the following:
a batch number;
a serial number;
a production date;
a percent extractables;
a durometer measure;
a hardness measure for the insulating material;
a fault code;
a yield rate;
a page count; and
an operating temperature.

4. The fuser member of claim 2 wherein at least a portion of the data is used to affect the operating conditions of the fuser member.

5. The fuser member of claim 2 wherein at least a portion of the data is used to evaluate one or more performance characteristics of the fuser member.

6. The fuser member of claim 1 wherein the RFID tag operates at a temperature up to at least 200° C.

7. The fuser member of claim 1 wherein the RFID tag comprises an active RFID tag.

8. The fuser member of claim 1 wherein the RFID tag comprises a passive RFID tag.

9. The fuser member of claim 1 wherein the fuser member is designed to be used in a xerographic apparatus.

10. The fuser member of claim 1 wherein the RFID tag is attached using an adhesive.

11. The fuser member of claim 1 wherein the RFID tag is attached using a band.

12. (canceled)

13. The fuser member of claim 12 wherein the core comprises a metal.

14. A method for evaluating performance of a fuser member, the method comprising:
manufacturing a fuser member;
attaching an RFID tag to the fuser member;
storing production data pertaining to the fuser member in the RFID tag;
using the fuser member in a xerographic apparatus;
storing run-time data in the RFID tag during operation of the xerographic apparatus; and
evaluating performance of the fuser member based on the run-time data.

15. The method of claim 14, further comprising:
reading at least a portion of the production data from the RFID tag; and
modifying one or more settings for the xerographic apparatus based on the production data.

16. The method of claim 14, further comprising:
modifying one or more fuser member manufacturing, conditions based on the run-time data.

17. The method of claim 14, wherein the production data comprises one or more of the following:
a batch number;
a serial number;
a production date;
a percent extractables;
a durometer measure; and
a hardness measure for the insulating material.

18. The method of claim 14, wherein the run-time data comprises one or more of the following:
a fault code;
a yield rate;
a pace count; and
an operating temperature.
